(19) United States
(12) Patent Application Publication
(10) Pub. No.: US 2026/0226381 A1
(43) Pub. Date: Aug. 6, 2026

(54) SYSTEM, INSTALLATION AND METHOD OF CONDITIONING SUGAR-CONTAINING JUICES OR LIQUIDS FOR THE PURPOSE OF THEIR ALCOHOLIC FERMENTATION

(71) Applicant: Gilbert Sonnay, Lucens (CH)

(72) Inventor: Gilbert Sonnay, Lucens (CH)

(21) Appl. No.: 19/148,489

(22) PCT Filed: Jan. 15, 2024
(86) PCT No.: PCT/IB2024/095001

§ 371 Date: Jul. 16, 2025

(30) Foreign Application Priority Data
Jan. 16, 2023 (EP) 23151850.7

(51) Int. Cl. C12G 3/08; C12G 1/00

(52) U.S. Cl. CPC C12G 3/08; C12G 1/00

(57) ABSTRACT

There is in particular described a system (10) of conditioning sugar-containing juices or liquids (M) for the purpose of their alcoholic fermentation, comprising at least one conditioning circuit (100) capable of allowing circulation of a sugar-containing juice or liquid (M), such as fruit juices or fruit musts. The conditioning circuit (100) comprises in particular a supply duct (100.1) capable of allowing the juice or liquid (M) to be taken from a tank (C) or other storage space for the juice or liquid (M). The conditioning circuit (100) further comprises a conditioning duct (100.2) coupled with an inlet (100.2A) to the supply duct (100.1) and capable of being crossed by the juice or liquid (M). The conditioning circuit (100) further comprises an outlet duct (100.3) coupled to an outlet (100.2B) of the conditioning duct (100.2) and capable of allowing the delivery of the conditioned juice or liquid (M) by means of the conditioning duct (100.2) to a tank (C) or other storage space for the conditioned juice or liquid (M). The conditioning duct (100.2) comprises the series arrangement of at least one magnetic or electromagnetic conditioning device (100M) intended to subject the juice or liquid (M) to a magnetic action and at least one dynamization device (100V), arranged before or after the magnetic or electromagnetic conditioning device (100M), capable of subjecting the juice or liquid (M) to mechanical stirring. Furthermore, each dynamization device (100V) is configured to subject the juice or liquid (M) to mechanical stirring according to a swirling path and comprises a tube section (100Va) provided with an inlet connector (100VA) and an outlet connector (100VB) configured to induce formation of a vortex (VRTX) extending longitudinally inside the tube section (100Va) between the inlet connector (100VA) and the outlet connector (100VB) of the dynamization device (100V).

### TECHNICAL FIELD

The present invention relates generally to a system and method of conditioning sugar-containing juices or liquids for the purpose of their alcoholic fermentation. The present invention also relates to an installation for conditioning such juices or liquids comprising such a conditioning system. The present invention is particularly applicable to the conditioning of grape musts for the purpose of their vinification.

### TECHNOLOGICAL BACKGROUND

As part of the winemaking process for grape musts and juices, it is typically customary to provide additives, particularly sulfites, to act as protection against possible spoilage. Sulfites are particularly used for their antioxidant and antiseptic properties. Unfortunately, the addition of sulfites can also cause reactions such as headaches and even allergic reactions in people who are sensitive to them. Sulfites are also classified as allergenic additives.

Reducing sulfites is therefore a health issue, as well as an image issue insofar as the trend towards offering “sulfite-free” wines (at least without added sulfites) is continually growing. The presence of sulfites cannot, however, be completely ruled out insofar as sulfites are naturally produced, even in small quantities, during the alcoholic fermentation process.

The addition of sulfites, or other additives with antioxidant and/or antiseptic properties, is also not fundamentally compatible with the implementation of an organic or biodynamic winemaking process that is consistent with an approach that aims to be sustainable.

It is therefore desirable to find solutions that make it possible to limit, or even completely eliminate, the use of additives.

International (PCT) application No. WO 2020/194206 A1 and its derivatives, including US patent application No. US 2022/0184569 A1, relate to a device for treating fluids by electromagnetism and stirring, in particular for the treatment of food fluids such as wines or distilled spirits. More specifically, the treatment device comprises a stirring element and at least one magnetic device, the stirring element being in particular made up of a tube section of determined length comprising several grooves (or fins) arranged inside the tube section in order to constrain the fluids to follow a non-linear trajectory through the stirring element. The grooves are for example produced in the form of a succession of helical elements arranged inside the tube section of the stirring element. Said at least one magnetic device is arranged around the stirring element at locations not comprising grooves.

It will therefore be understood that International (PCT) application No. WO 2020/194206 A1 describes a solution where the fluid passing through the stirring element is forced to follow a trajectory determined by the arrangement of the grooves in order to induce disturbances in the flow of the fluid. This solution is not optimal and relatively complex to implement in that it requires the manufacture of a specific element carrying the required grooves and its insertion inside the tube section of the stirring element, which is likely to lead to clogging or even obstruction of the stirring element.

A simpler solution to implement is therefore desirable.

### STATEMENT OF THE INVENTION

A general aim of the present invention is to propose a system and a method of conditioning sugar-containing juices and liquids for the purpose of their alcoholic fermentation which overcomes the drawbacks and limitations of the solutions of the state of the art.

In particular, an aim of the present invention is to propose such a solution which limits, or even avoids the use of additives, such as sulfites, in the alcoholic fermentation process.

Another aim of the invention is to propose such a solution which is inexpensive to produce and implement.

Yet another aim of the present invention is to propose such a solution which ensures that the juice or liquid thus conditioned is compatible with processes meeting a requirement of essentially organic or biodynamic agriculture and production, respectful of the product and consumers.

The present invention responds at least in part to these aims by providing a system of conditioning sugar-containing juices or liquids for the purpose of their alcoholic fermentation, the features of which are recited in claim 1, namely such a conditioning system comprising at least one conditioning circuit capable of allowing circulation of a sugar-containing juice or liquid, such as fruit juices or fruit musts. The conditioning circuit in particular comprises a supply duct capable of allowing the juice or liquid to be withdrawn from a tank or other storage space for the juice or liquid. The conditioning circuit further comprises a conditioning duct coupled at an inlet to the supply duct and capable of being flowed through by the juice or liquid. The conditioning circuit additionally comprises an outlet duct coupled to an outlet of the conditioning duct and capable of allowing the delivery of the juice or liquid conditioned by means of the conditioning duct to a tank or other storage space for the conditioned juice or liquid. According to the invention, the conditioning duct comprises the series arrangement of at least one magnetic or electromagnetic conditioning device intended to subject the juice or liquid to a magnetic action and at least one dynamization device, arranged before or after the magnetic or electromagnetic conditioning device, capable of subjecting the juice or liquid to mechanical stirring. Furthermore, each dynamization device is configured to subject the juice or liquid to mechanical stirring according to a swirling path and comprises a tube section provided with an inlet connector and an outlet connector configured to induce formation of a vortex extending longitudinally inside the tube section between the inlet connector and the outlet connector of the dynamization device.

According to an advantageous embodiment, the conditioning duct comprises the series arrangement of several duct segments, each comprising the series arrangement of a magnetic or electromagnetic conditioning device and a dynamization device.

Advantageously, the tube section of the dynamization device is free from elements likely to hinder the flow of juice or liquid through the dynamization device as well as the formation of the vortex between the inlet connector and the outlet connector of the dynamization device.

According to a particularly preferred embodiment, each of the inlet connector and outlet connector of the dynamization device has a terminal portion provided at its distal end with a depression participating in the formation of the vortex, in particular a depression having a substantially spherical concave surface. Furthermore, each terminal portion preferably has a substantially conical outer surface.

Preferably, each magnetic or electromagnetic conditioning device comprises a tube section inside which is arranged a magnetic or electromagnetic core so that the juice or liquid is caused to circulate through an intercalary space remaining between the magnetic or electromagnetic core and an internal circumference of the tube section of the magnetic or electromagnetic conditioning device. In this context, the magnetic or electromagnetic core may in particular comprise an alternation of magnetic or electromagnetic elements of reversed poles separated by spacers. These magnetic or electromagnetic elements separated by the spacers are preferably arranged inside a tubular element retained at each end inside the tube section. Furthermore, the tube section of the magnetic or electromagnetic conditioning device may advantageously be provided with an inlet connector and an outlet connector configured to retain the magnetic or electromagnetic core inside the tube section of the magnetic or electromagnetic conditioning device, which inlet and outlet connectors are preferably configured to induce a rotational movement of the juice or liquid around the magnetic or electromagnetic core.

The conditioning system according to the invention is advantageously used for conditioning sugar-containing juices or liquids for the purpose of their alcoholic fermentation. More specifically, the conditioning system according to the invention is preferably used for conditioning grape musts or grape juices as part of a winemaking process, but other applications are conceivable, in particular in the context of the production of ciders or other alcohols or alcoholic beverages.

The invention also relates to an installation for conditioning sugar-containing juices or liquids for the purpose of their alcoholic fermentation, comprising a conditioning system according to the invention coupled to a pump capable of ensuring circulation of the juice or liquid through the conditioning circuit and at least one storage tank containing the juice or liquid to be conditioned.

The supply duct and the outlet duct of the conditioning system may in particular be coupled to the same storage tank in order to subject the juice or liquid to one or more conditioning cycles, in particular two to four cycles.

The invention also relates to a method of conditioning sugar-containing juices or liquids for the purpose of their alcoholic fermentation, the features of which are recited in independent claim 13, namely such a method comprising the circulation of a sugar-containing juice or liquid, such as fruit juices or fruit musts, in a conditioning circuit configured to subject the juice or liquid circulating through the conditioning circuit to a magnetic action as well as to dynamization by mechanical stirring. According to the method of the invention, the juice or liquid is subjected to mechanical stirring according to a swirling path by inducing of a vortex extending longitudinally inside at least one tube section of the conditioning circuit, said tube section being provided with an inlet connector and an outlet connector configured to induce formation of said vortex between the inlet connector and the outlet connector.

This method is preferably implemented by means of the conditioning system according to the invention or the conditioning installation according to the invention.

The conditioning method according to the invention is in particular implemented for the conditioning of grape musts or grape juices as part of a winemaking process, it being recalled once again that other applications are conceivable.

Other aspects of the invention are set forth in the remainder of this description.

### SUMMARY DESCRIPTION OF THE DRAWINGS

The features and advantages of the present invention will become more apparent upon reading the following detailed description of various embodiments of the invention, which are presented solely as non-limiting examples and are illustrated by the appended drawings where:

FIG. 1 is a schematic view of a conditioning installation according to a preferred embodiment of the invention, which includes a conditioning system comprising a conditioning duct comprising the series arrangement of several duct segments each comprising a magnetic conditioning device and a vortex-inducing dynamization device;

FIG. 2 is a schematic side view of one of the magnetic conditioning devices of FIG. 1;

FIGS. 3A and 3B are schematic views, respectively a side view and a front view, of a connector arranged at the inlet and outlet of a tube section of the magnetic conditioning device of FIG. 2;

FIGS. 4A and 4B are schematic views, respectively a side view and a cross-sectional view taken longitudinally, of a magnetic core of the magnetic conditioning device of FIG. 2 which is held between the inlet and outlet connectors;

FIG. 5 is a schematic side view of one of the vortex-inducing dynamization devices of FIG. 1;

FIGS. 6A and 6B are schematic views, respectively a side view and a front view, of a connector arranged at the inlet of a tube section of the vortex-inducing dynamization device of FIG. 5; and

FIGS. 7A and 7B are schematic views, respectively a side view and a front view, of a connector arranged at the outlet of the tube section of the vortex-inducing dynamization device of FIG. 5.

### MODES OF EMBODIMENT OF THE INVENTION

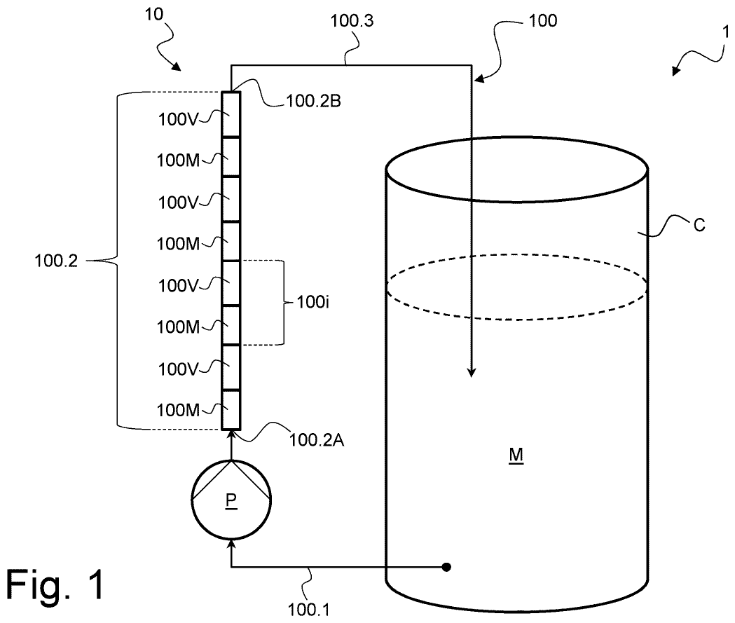

The present invention will be described with reference to various preferred embodiments as illustrated in particular by FIGS. 1 to 7A-B.

FIG. 1 is a schematic view of a conditioning installation, generally designated by the reference numeral 1, according to a preferred embodiment of the invention. This conditioning installation 1 comprises a conditioning system 10 comprising at least one conditioning circuit 100 capable of allowing circulation of a sugar-containing juice or liquid intended to undergo an alcoholic fermentation process, here grape must or grape juice M which is stored in a tank C (or other suitable storage space, such as a barrel).

The conditioning circuit 100 comprises a supply duct 100.1 capable of allowing the juice or liquid M to be withdrawn from the tank C, a conditioning duct 100.2 coupled at an inlet 100.2A to the supply duct 100.1 and capable of being flowed through by the juice or liquid M, as well as an outlet duct 100.3 coupled to an outlet 100.2B of the conditioning duct 100.2 and capable of allowing the delivery of the juice or liquid M conditioned by means of the conditioning duct 100.2. In the illustrated example, the outlet duct 100.3 returns the conditioned juice or liquid M (at least a first time) to the same tank C, so that the juice or liquid M can undergo several conditioning cycles.

The conditioning installation 1 illustrated in FIG. 1 also comprises a pump P capable of ensuring the circulation of the juice or liquid M through the conditioning circuit 100. In the illustrated example, the pump P is placed in the supply duct 100.1, but it is understood that this pump could be arranged in any other suitable portion of the conditioning circuit 100.

In other embodiments, the conditioned juice or liquid M may be delivered to another tank or other suitable storage space. In practice, the outlet duct of the conditioning circuit could comprise two separate branches, one allowing the conditioned juice or liquid M to be returned to tank C, the other to another tank (or other storage space).

In the illustrated example, only one conditioning circuit 100 is provided, but it will be understood that several conditioning circuits could possibly be arranged in parallel. Similarly, several conditioning ducts 100.2 could be provided in parallel in the same conditioning circuit.

According to the invention, the conditioning duct 100.2 comprises at least one magnetic (or even electromagnetic) conditioning device, designated 100M, which is intended to subject the juice or liquid M to a magnetic action. In the illustrated example, the conditioning duct 100.2 in fact preferably comprises the series arrangement of several duct segments 100i (here four in number) each comprising a magnetic (or even electromagnetic) conditioning device 100M. In the remainder of this description, when reference is made to the concept of “magnetic conditioning”, it will be understood that reference is made indifferently to conditioning carried out by means of magnetic or electromagnetic devices and/or elements. Each duct segment 100i further comprises a dynamization device, designated 100V, arranged in series, after (or alternatively before) the magnetic conditioning device 100M, which dynamization device 100V is configured to subject the juice or liquid M to mechanical stirring according to a swirling path, as described below. In the particular illustrated case, a dynamization device 100V is arranged after each magnetic conditioning device 100M.

The magnetic conditioning device 100M could take various forms. Particularly preferably, the magnetic conditioning device 100M is of a type known per se, as described for example in International (PCT) application No. WO 86/04887 A1, the contents of which are incorporated herein by reference in their entirety. The magnetic conditioning device 100M described in International (PCT) application No. WO 86/04887 A1 (see also European Patent EP 0 215 013 B1 which is derived from this international application) is conventionally used in dwelling water ducts for the purpose of reducing or avoiding limescale deposits. The use of this type of device for these purposes has demonstrated its effectiveness.

The conditioning carried out by means of the conditioning system according to the invention has the particular purpose of increasing the balance of particles and ions in solution in the juice or liquid being conditioned thanks to the magnetic action, while dynamizing this juice or liquid thanks to the subsequent mechanical stirring. Significant qualitative benefits have in particular been observed following various tests carried out on grape musts and grape juices for the purpose of their vinification.

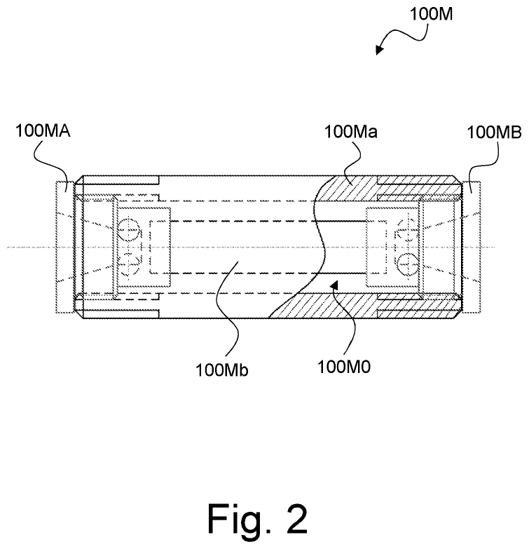

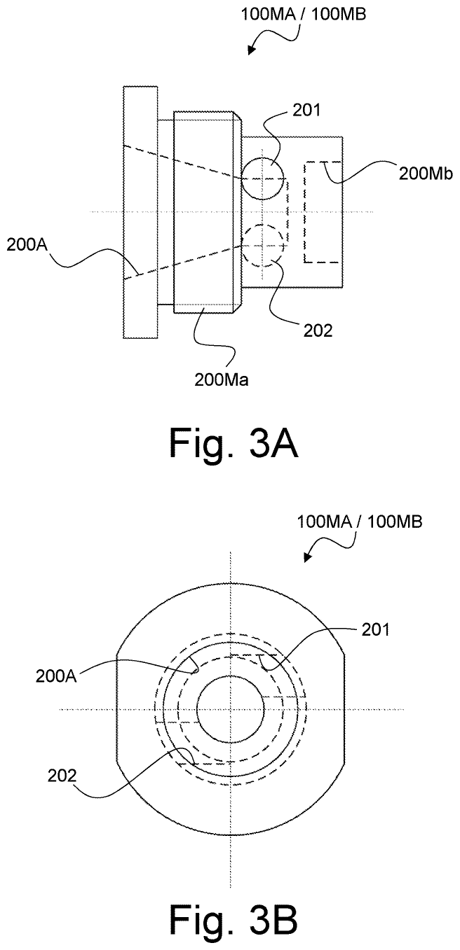

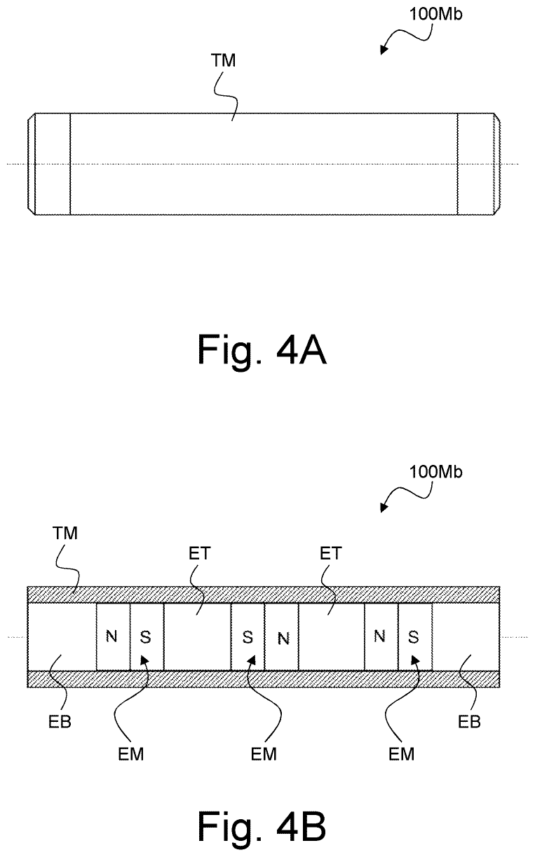

FIG. 2 is a schematic side view of one of the magnetic conditioning devices 100M of FIG. 1, which comprises a tube section 100Ma inside which is arranged a magnetic core 100Mb (illustrated more specifically in FIGS. 4A and 4B) so that the juice or liquid M can circulate through the tube section 100Ma and around the magnetic core 100Mb, namely in an intercalary space, designated 100M0 remaining between the magnetic core 100Mb and the internal circumference of the tube section 100Ma. At each end of the tube section 100Ma is arranged an inlet connector 100MA, respectively an outlet connector 100MB, which ensures the passage of the juice or liquid M, as well as retention of the magnetic core 100Mb (see also FIGS. 3A and 3B).

In view of the above, it will therefore be understood that the magnetic core 100Mb forms a core extending longitudinally in the center of the tube section 100Ma and retained at each end by the inlet 100MA and outlet 100MB connectors, the juice or liquid M being caused to circulate around this core in the intercalary space 100M0.

As illustrated in FIGS. 3A and 3B, the inlet and outlet connectors 100MA, 100MB each have an inlet port, respectively an outlet port 200A (here of substantially conical shape) which communicates with a pair of lateral openings 201, 202 which are here offset from each other, on either side of the longitudinal axis. This arrangement of the lateral openings 201, 202 advantageously makes it possible to impart a rotational movement of the juice or liquid M around the magnetic core 100Mb.

In the illustrated example, the inlet and outlet connectors 100MA, 100MB each have a threaded portion 200Ma which is sized and configured to be fastened to a corresponding end of the tube section 100Ma, itself provided with a corresponding thread (not referenced). Furthermore, the inlet and outlet connectors 100MA, 100MB each further have a bore 200Mb which is sized to cooperate with a corresponding end of the magnetic core 100Mb and thus retain the magnetic core 100Mb inside the tube section 100Ma (as illustrated in FIG. 2).

As illustrated in the preferred example of FIGS. 4A and 4B, the magnetic core 100Mb essentially comprises a tubular element TM inside which are arranged several magnetic elements EM separated by spacers ET. More specifically, the magnetic elements EM are arranged so that they form an alternation of magnetic elements with reversed poles EM (here three in number) separated by the spacers ET (here two in number). Sockets EB acting as plugs are also arranged at each end of the tubular element TM.

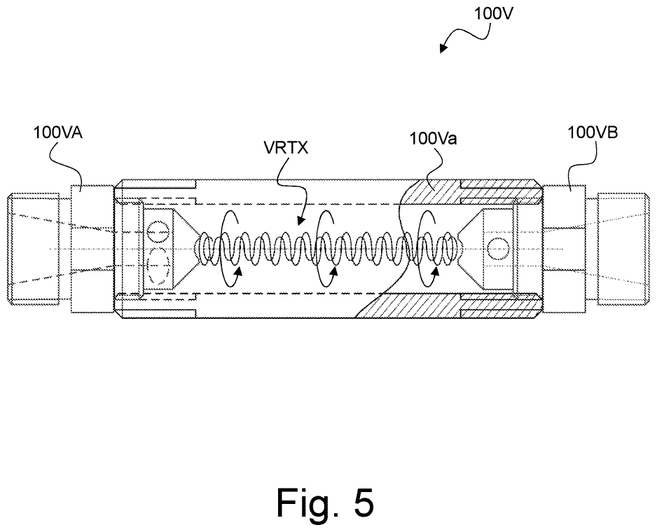

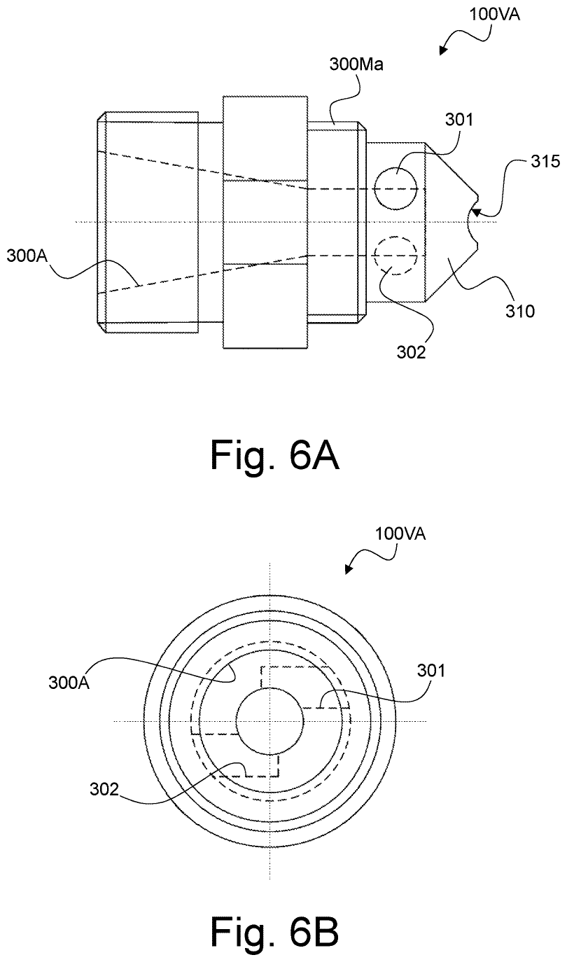

FIG. 5 is a schematic side view of one of the dynamization devices 100V of FIG. 1, which comprises a tube section 100Va at the ends of which are arranged an inlet connector 100Va and an outlet connector 100VB which ensure the passage of the juice or liquid M through the tube section 100Va (see also FIGS. 6A-B and 7A-B).

According to the invention, each dynamization device 100V is configured to generate a vortex VRTX that extends longitudinally inside the tube section 100Va between the inlet 100VA and the outlet 100VB of the dynamization device 100V, as schematically illustrated in FIG. 5. To this end, the inlet and outlet connectors 100VA and 100VB are specifically configured to induce formation of this vortex VRTX between the inlet connector 100VA and the outlet connector 100VB of the dynamization device 100V.

The vortex VRTX thus formed causes the juice or liquid M to circulate through the dynamization device 100V and undergo mechanical stirring according to a swirling path, namely in a rotational movement around a longitudinal axis substantially coinciding with the longitudinal axis of the tube section 100Va. The flow of the juice or liquid M through the dynamization device 100V thus occurs according to a swirling movement, without it being necessary to place fins or other mechanical elements in the flow of the juice or liquid M. On the contrary, as illustrated, the tube section 100Va of the dynamization device 100V is advantageously free of elements likely to hinder the flow of the juice or liquid M through the dynamization device 100V as well as the formation of the vortex VRTX between the inlet connector 100VA and the outlet connector 100VB of the dynamization device 100V, thus leading to the implementation of a more optimal and easier solution than that described for example in International (PCT) application No. WO 2020/194206 A1 cited in the preamble.

With regard to the embodiment illustrated in FIGS. 6A and 6B, it can thus be seen that the inlet connector 100VA has an inlet port, 300A (here of substantially conical shape) which communicates with a pair of lateral openings 301, 302 which are here offset from one another, on either side of the longitudinal axis. The geometry of the terminal portion 310 of the inlet connector 100VA, arranged downstream of the lateral openings 301, 302 is also chosen to promote the formation of the vortex VRTX and allow it to be maintained. More specifically, the terminal portion 310 of the inlet connector 100VA preferably has a depression 315, advantageously having a substantially spherical concave surface, which is formed at the distal end of the terminal portion 310, as illustrated in FIG. 6A. In the example illustrated, the inlet connector 100VA further has a threaded portion 300Ma which is sized and configured to be fastened to the corresponding end of the tube section 100Va, itself provided with a corresponding thread (not referenced).

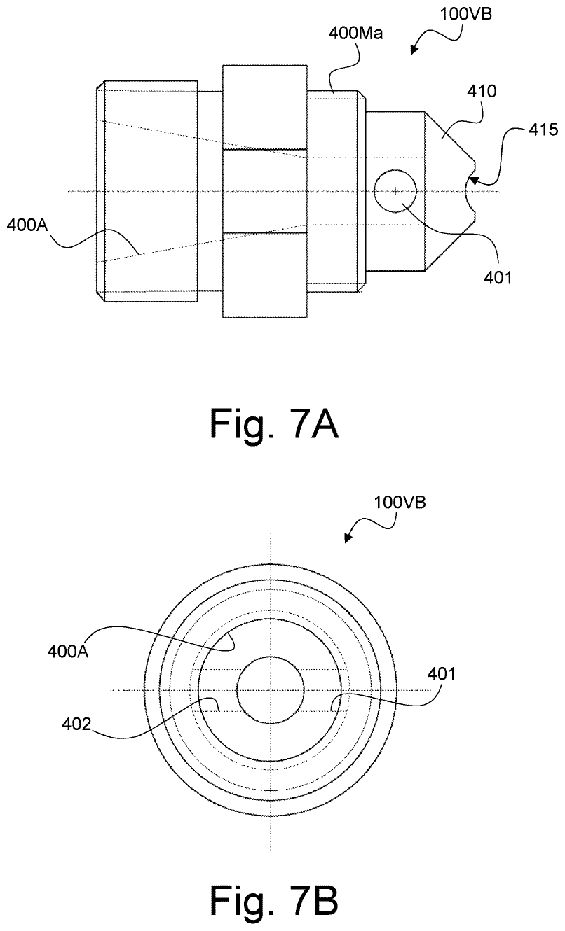

As illustrated in FIGS. 7A and 7B, the outlet connector 100VB is substantially similar to the inlet connector 100VA and likewise comprises an outlet port 400A which communicates with a pair of lateral openings 401, 402, as well as a threaded portion 400Ma which is sized and configured to be fastened to the other end of the tube section 100Va, itself provided with a corresponding thread (not referenced). The outlet connector 100VB differs from the inlet connector 100VA by the arrangement of the lateral openings 401, 402 which are here arranged in the same plane and oriented in opposite directions.

Like the inlet connector 100VA, the geometry of the terminal portion 410 of the outlet connector 100VB, arranged upstream of the lateral openings 401, 402, is also chosen to promote the formation of the vortex VRTX and allow it to be maintained. More specifically, the terminal portion 410 of the outlet connector 100VB also preferably has a depression 415, advantageously having a substantially spherical concave surface, which is formed at the distal end of the terminal portion 410, as illustrated in FIG. 7A.

In the illustrated example, the terminal portions 310, 410 of the inlet and outlet connectors 100VA, 100VB each advantageously have a substantially conical outer surface, but other geometries could possibly be envisaged without compromising the desired formation of the vortex VRTX inside the dynamization device 100V.

The arrangement of the aforementioned inlet and outlet connectors 100VA, 100VB thus makes it possible to generate a vortex VRTX within the tube section 100Va to subject the juice or liquid M passing through the dynamization device 100V to mechanical stirring according to a swirling path, which ensures dynamization of the juice or liquid passing through the conditioning system 10. The particular geometry of the inlet and outlet connectors 100VA, 100VB advantageously makes it possible to influence the characteristics of the vortex VRTX and the rotational speed of the juice or liquid M within the tube section 100Va which varies radially, without it being necessary to resort to fins or other mechanical elements placed in the flow of the juice or liquid M.

Tests carried out using a prototype of the conditioning installation shown schematically in the Figures have shown a beneficial effect on the juice or liquid thus conditioned, namely a significant reduction in the proliferation of mold, without the addition of antioxidant and antiseptic additives. Qualitative and taste tests have also shown a beneficial effect on aromas and flavors, as well as on the development of the wine during its vinification, without the use of additives such as sulfites.

As already mentioned, the juice or liquid M is preferably subjected to several conditioning cycles. In particular, significant benefits have been observed after two to four successive cycles.

The juice or liquid processing flow rates will be adapted according to the needs and the nature of the juice or liquid to be conditioned, as well as, in particular, its viscosity. In practice, processing flow rates can be in the order of 50 liters per hour to 1,000 liters per hour depending on the size of the installation.

It will be generally understood that various modifications and/or improvements obvious to those skilled in the art may be made to the embodiments described in the present description without departing from the scope of the invention defined by the appended claims.

In particular, although the invention is particularly applicable to the conditioning of grape musts or grape juices as part of a winemaking process, the invention is fundamentally applicable to any conditioning of sugar-containing juices or liquids for the purpose of their alcoholic fermentation, whether they are juices or liquids originating from fruit pressing or from other suitable sources. In other words, the invention may be applied to the conditioning of any other juice or liquid intended for an alcoholic fermentation process, for example for the production of ciders or other alcohols or alcoholic beverages.

Furthermore, it should be noted that the magnetic (or electromagnetic) conditioning devices could have any other suitable configuration. Thus, it could be envisaged, in other embodiments, to arrange the required magnetic (or electromagnetic) elements outside a corresponding tube section rather than in a magnetic (or electromagnetic) core as described with reference to FIGS. 2 to 4A-B. The use of conditioning devices with a magnetic (or electromagnetic) core remains preferred, however, in that it appears to lead to meaningful beneficial results.

### LIST OF REFERENCE SIGNS USED IN THIS DESCRIPTION AND IN THE DRAWINGS

1 conditioning installation according to a preferred embodiment of the invention
10 conditioning system according to a preferred embodiment of the invention
100 conditioning circuit of the conditioning system 10
100.1 supply duct of the conditioning circuit 100
100.2 conditioning duct of the conditioning circuit 100
100.2A inlet of conditioning duct 100.2 coupled to the supply duct 100.1
100.2B outlet of conditioning duct 100.2 coupled to the outlet duct 100.3
100.3 outlet duct of the conditioning circuit 100
100i conditioning duct segments
100M magnetic (or electromagnetic) conditioning device
100Ma tube section of the magnetic conditioning device 100M
100Mb magnetic (or electromagnetic) core
100M0 intercalary space between magnetic core 100Mb and internal circumference of tube section 100Ma
TM tubular element of the magnetic core 100Mb
EM magnetic (or electromagnetic) elements of the magnetic (or electromagnetic) core 100Mb
ET spacers of the magnetic core 100Mb
EB sockets arranged at the ends of the 100Mb magnetic core
100MA inlet of the magnetic conditioning device 100M/inlet connector
100MB outlet of the magnetic conditioning device 100M/outlet connector
100V dynamization device
100Va tube section of the dynamization device 100V
100VA inlet of the dynamization device 100V/inlet connector
100VB outlet of the dynamization device 100V/outlet connector
200A inlet/outlet port of the inlet/outlet connector 100MA/100MB
201 (first) lateral opening of the inlet/outlet connector 100MA/100MB
202 (second) lateral opening of the inlet/outlet connector 100MA/100MB
200Ma thread of the inlet/outlet connector 100MA/100MB for screwing onto the corresponding end of the tube section 100Ma
200Mb bore of the inlet/outlet connector 100MA/100MB for holding the corresponding end of the magnetic core 100Mb
300A inlet port of the inlet connector 100VA
301 (first) lateral opening of the inlet connector 100VA
302 (second) lateral opening of the inlet connector 100VA
300Ma thread of the inlet connector 100VA for screwing onto the corresponding end of the tube section 100Va
310 terminal portion of the inlet connector 100VA participating in the inducing of the vortex VRTX
315 depression formed at the distal end of the terminal portion 310 of the inlet connector 100VA
400A outlet port of the outlet connector 100VB
401 (first) lateral opening of the outlet connector 100VB
402 (second) lateral opening of the outlet connector 100VB
400Ma thread of the outlet connector 100VB for screwing onto the corresponding end of the tube section 100Va
410 terminal portion of the outlet connector 100VB participating in the inducing of the vortex VRTX
415 depression formed at the distal end of the terminal portion 410 of the outlet connector 100VB
M sugar-containing juice or liquid intended for an alcoholic fermentation process, in particular grape must or juice
C tank (or other storage space) containing the juice or liquid M
VRTX vortex induced longitudinally between the inlet connector 100VA and the outlet connector 100VB along the flow of juice or liquid M circulating through the dynamization device 100V

1.-18. (canceled)

19. A system of conditioning sugar-containing juices or liquids for the purpose of their alcoholic fermentation, comprising at least one conditioning circuit capable of allowing circulation of a sugar-containing juice or liquid, such as fruit juices or fruit musts,
the conditioning circuit comprising:
a supply duct capable of allowing the juice or liquid to be taken from a tank or other storage space for the juice or liquid;
a conditioning duct coupled at an inlet to the supply duct and capable of being flowed through by the juice or liquid; and
an outlet duct coupled to an outlet of the conditioning duct and capable of allowing the delivery of the juice or liquid conditioned by means of the conditioning duct to a tank or other storage space for the conditioned juice or liquid,
the conditioning duct comprising the series arrangement of at least one magnetic or electromagnetic conditioning device intended to subject the juice or liquid to a magnetic action and at least one dynamization device, arranged before or after the magnetic or electromagnetic conditioning device, capable of subjecting the juice or liquid to mechanical stirring,
wherein each dynamization device is configured to subject the juice or liquid to a mechanical stirring according to a swirling path and comprises a tube section provided with an inlet connector and an outlet connector which are configured to induce formation of a vortex extending longitudinally inside the tube section between the inlet connector and the outlet connector of the dynamization device.

20. The system according to claim 19, wherein the conditioning duct comprises the series arrangement of several duct segments each comprising the series arrangement of a magnetic or electromagnetic conditioning device and a dynamization device.

21. The system according to claim 19, wherein the tube section of the dynamization device is free of elements likely to hinder the flow of the juice or liquid through the dynamization device as well as the formation of the vortex between the inlet connector and the outlet connector of the dynamization device.

22. The system according to claim 19, wherein each of the inlet connector and outlet connector of the dynamization device has a terminal portion provided at its distal end with a depression participating in the formation of the vortex.

23. The system according to claim 22, wherein each depression has a substantially spherical concave surface.

24. The system according to claim 22, wherein each terminal portion has a substantially conical outer surface.

25. The system according to claim 19, wherein each magnetic or electromagnetic conditioning device comprises a tube section inside which is arranged a magnetic or electromagnetic core so that the juice or liquid is caused to circulate through an intercalary space remaining between the magnetic or electromagnetic core and an internal circumference of the tube section of the magnetic or electromagnetic conditioning device.

26. The system according to claim 25, wherein the magnetic or electromagnetic core comprises an alternation of magnetic or electromagnetic elements of reversed poles separated by spacers.

27. The system according to claim 26, wherein the magnetic or electromagnetic elements separated by the spacers are arranged inside a tubular element retained at each end inside the tube section of the magnetic or electromagnetic conditioning device.

28. The system according to claim 25, wherein the tube section of the magnetic or electromagnetic conditioning device is provided with an inlet connector and an outlet connector configured to retain the magnetic or electromagnetic core inside the tube section of the magnetic or electromagnetic conditioning device.

29. The system according to claim 28, wherein the inlet and outlet connectors of the magnetic or electromagnetic conditioning device are configured to induce a rotational movement of the juice or liquid around the magnetic or electromagnetic core.

30. A method of using the system according to claim 19 for conditioning sugar-containing juices or liquids for the purpose of their alcoholic fermentation.

31. A method of using the system according to claim 19 for conditioning grape musts or grape juices as part of a winemaking process.

32. An installation for conditioning sugar-containing juices or liquids for the purpose of their alcoholic fermentation, comprising a system according to claim 19 coupled to a pump capable of ensuring circulation of the juice or liquid through the conditioning circuit and at least one storage tank containing the juice or liquid to be conditioned.

33. The installation according to claim 32, wherein the supply duct and the outlet duct of the system are coupled to the same storage tank in order to subject the juice or liquid to one or more conditioning cycles, in particular two to four cycles.

34. A method of conditioning sugar-containing juices or liquids for the purpose of their alcoholic fermentation, comprising the circulation of a sugar-containing juice or liquid, such as fruit juices or fruit musts, in a conditioning circuit configured to subject the juice or liquid circulating through the conditioning circuit to a magnetic action as well as to dynamization by mechanical stirring,
wherein the juice or liquid is subjected to mechanical stirring according to a swirling path by inducing of a vortex extending longitudinally inside at least one tube section of the conditioning circuit, the tube section being provided with an inlet connector and an outlet connector configured to induce formation of the vortex between the inlet connector and the outlet connector.

35. The method according to claim 34, implemented for the conditioning of grape musts or grape juices as part of a winemaking process.
